(19) United States
(12) Patent Application Publication
(10) Pub. No.: US 2026/0184134 A1
(43) Pub. Date: Jul. 2, 2026

(54) HVAC FLUID INGRESSION MANAGEMENT SYSTEM

(71) Applicant: Hanon Systems, Daejeon (KR)

(72) Inventors: Jennifer Petrowski, Royal Oak, MI (US); Shane Harte, Novi, MI (US); Erick K. Haupt, Livonia, MI (US); Mark Douglas Conley, Canton, MI (US); Jayanthi Iyer, Northville, MI (US); Dennis Vermette, Westland, MI (US)

(21) Appl. No.: 19/001,748

(22) Filed: Dec. 26, 2024

(51) Int. Cl. B60H 1/00

(52) U.S. Cl. CPC B60H 1/00564; B60H 1/00514

(57) ABSTRACT

An air-handling system for a heating, ventilation, and air conditioning system comprises a main housing, one or more selectively positionable doors, and a fluid ingression management system. The fluid ingression management system includes a fluid passageway configured to permit a flow of fluid (e.g., water) from an air inlet of the air-handling system to an exterior thereof. The fluid passageway may be defined by a tube-like structure or at least one fluid channel formed in the main housing.

### FIELD

The invention relates to a climate control system for a vehicle and more particularly to fluid ingression management system for a heating, ventilating, and air conditioning system for the vehicle.

### BACKGROUND

A vehicle typically includes a climate control system which maintains a temperature within a passenger compartment of the vehicle at a comfortable level by providing heating, cooling, and ventilation. Comfort is maintained in the passenger compartment by an integrated mechanism referred to in the art as a heating, ventilation and air conditioning (HVAC) air-handling system. The air-handling system commonly employs a blower assembly, an evaporator core, a heater core, and a plurality of selectively positionable doors within a housing to condition air flowing therethrough and distributes the conditioned air throughout the passenger compartment.

Fluid ingress (or water intrusion) into the air-handling system can lead to various operational and performance issues. These problems arise when fluid enters the air-handling system through an air inlet of the blow assembly. The undesired fluid reduces efficiency and causes damage that results in costly repairs. For instance, the fluid ingress can cause components like ducts, coils, and electrical systems to corrode over time, leading to degraded performance, reduced lifespan, or complete system failure. Fluid ingress to electrical components and systems, such as wiring, motors, and circuit boards, can be especially dangerous since it can lead to electrical shorts, malfunctions, or even fire caused by short-circuiting. Additionally, any excess moisture resulting from the fluid ingress can cause the air-handling system to work harder to maintain desired temperature and humidity levels. This leads to increased energy consumption and lower efficiency as well as increased wear on the overall system. Furthermore, if fluid accumulates in undesired locations within the air-handling system, it creates a damp environment that promotes the growth of mold and mildew, or especially in colder climates, it can freeze and cause damage to the structure and/or components of the air-handling system. This fluid accumulation can also “bubble” resulting in undesirable noise and customer dissatisfaction.

Conventional air-handling systems provide a drain to route the ingested fluid to an exterior of the vehicle. However, when the fluid is ingested during an operation of the blower assembly, the fluid collects in the air inlet because of back pressure therewithin, and therefore, does not properly flow through the drain provided.

Accordingly, it would be desirable to develop an air-handling system with improved fluid ingression management to minimize an accumulation of a fluid therewithin.

### SUMMARY

In concordance and agreement with the presently described subject matter, an air-handling system with improved fluid ingression management to minimize an accumulation of a fluid therewithin, has been newly designed. Shortcomings of the prior art are overcome, and additional advantages are provided through the systems and the methods in accordance with the present disclosure.

In embodiments of the present disclosure, an air-handling system for a heating, ventilation, and air conditioning system of a vehicle, comprises: a main housing having an air inlet; and a fluid ingression management system including a fluid drain in fluid communication with the air inlet, a fluid outlet in fluid communication with an exterior of the air-handling system, and a fluid passageway disposed between the fluid drain and the fluid outlet, wherein the fluid passageway is configured to permit a flow of a fluid from the air inlet to the exterior of the air-handling system.

As aspects of some embodiments, a tube-like structure defines the fluid passageway.

As aspects of some embodiments, the tube-like structure extends from the fluid drain.

As aspects of some embodiments, one end of the tube-like structure is in fluid communication with the fluid drain and another end of the tube-like structure is a free end.

As aspects of some embodiments, the tube-like structure extends between the fluid drain and the fluid outlet.

As aspects of some embodiments, one end of the tube-like structure is in fluid communication with the fluid drain and another end of the tube-like structure is in fluid communication with the fluid outlet.

As aspects of some embodiments, one end of the tube-like structure is directly connected to the fluid drain.

As aspects of some embodiments, one end of the tube-like structure is directly connected to the fluid outlet.

As aspects of some embodiments, a length of the tube-like structure is at least about 50 mm.

As aspects of some embodiments, a length of the tube-like structure is in a range of about 50 mm to about 300 mm.

As aspects of some embodiments, a length of the tube-like structure is about 80 mm.

As aspects of some embodiments, a length of the tube-like structure is about 250 mm.

As aspects of some embodiments, an inner diameter of the tube-like structure is in a range of about 5 mm to about 10 mm.

As aspects of some embodiments, one or more fluid channels define the fluid passageway.

As aspects of some embodiments, one end of the fluid channels is in fluid communication with the fluid drain and another end of the fluid channels is in fluid communication with the fluid outlet.

As aspects of some embodiments, one end of the fluid channels is directly connected to the fluid drain.

As aspects of some embodiments, one end of the fluid channels is directly connected to the fluid outlet.

As aspects of some embodiments, a portion of the fluid channels is at an angle in range of about 3 degrees to about 10 degrees relative to a horizontal axis to facilitate the flow of the fluid away from the fluid drain.

As aspects of some embodiments, a portion of the fluid channels is relatively parallel to a vertical axis.

As aspects of some embodiments, at least a portion of the fluid channels is formed in a wall of the main housing.

### BRIEF DESCRIPTION OF THE DRAWINGS

The above, as well as other advantages of the present disclosure, will become readily apparent to those skilled in the art from the following detailed description, particularly when considered in the light of the drawings described hereinafter.

FIG. 1 is a cross-sectional view showing an interior of a main housing of an air-handling system according to an embodiment of the invention, wherein a fluid drain of a fluid ingression management system is shown;

FIG. 2 is a cross-sectional view showing an interior of a main housing of an air-handling system according to an embodiment of the invention, wherein fluid ingression management system comprises a tube-like structure extending from a fluid drain;

FIG. 3 is a cross-sectional view showing an interior of a main housing of an air-handling system according to another embodiment of the invention, wherein fluid ingression management system comprises a tube-like structure extending from a fluid drain to a fluid outlet;

FIG. 4 is an enlarged fragmentary perspective view of the fluid ingression management system of FIG. 3;

FIG. 5 is an enlarged fragmentary top perspective view of the fluid ingression management system of FIGS. 3 and 4;

FIG. 6 is an enlarged fragmentary bottom perspective view of the fluid ingression management system of FIGS. 3-5;

FIG. 7 is an enlarged fragmentary perspective view showing an interior of a main housing of an air-handling system according to another embodiment of the invention, wherein fluid ingression management system comprises one or more fluid channels extending from a fluid drain to a fluid outlet;

FIG. 8 is an enlarged fragmentary bottom perspective view showing the fluid ingression management system of FIG. 7;

FIG. 9 is another enlarged fragmentary bottom perspective view showing the fluid ingression management system of FIGS. 7 and 8;

FIG. 10 is an enlarged fragmentary elevational view showing the fluid ingression management system of FIGS. 7-9; and

FIG. 11 is an enlarged fragmentary bottom perspective view showing a fluid outlet of the fluid ingression management system of FIGS. 7-10.

### DETAILED DESCRIPTION

The following description of technology is merely exemplary in nature of the subject matter, manufacture and use of one or more present disclosures, and is not intended to limit the scope, application, or uses of any specific present disclosure claimed in this application or in such other applications as may be filed claiming priority to this application, or patents issuing therefrom. Regarding methods disclosed, the order of the steps presented is exemplary in nature, and thus, the order of the steps may be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

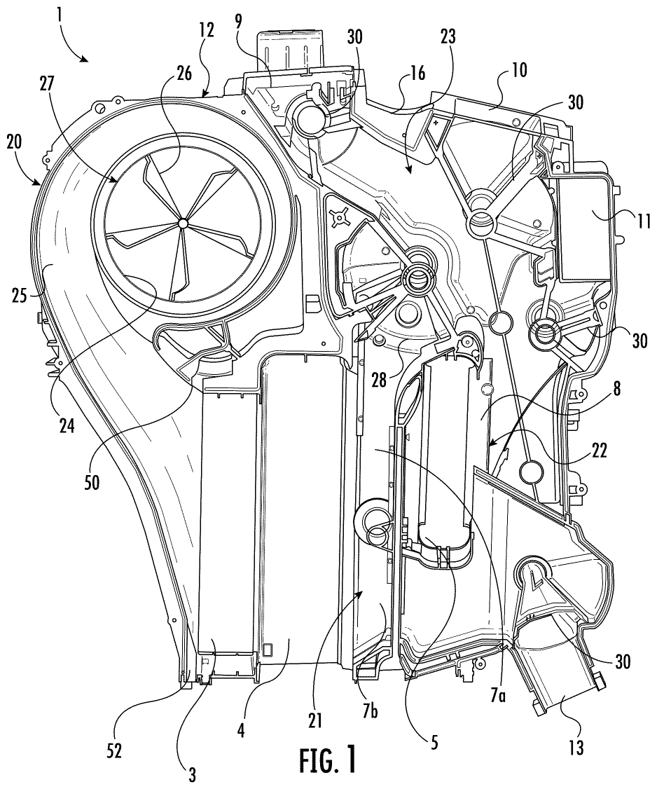

FIG. 1 illustrates an air-handling system 1 of a heating, ventilating, and air conditioning (HVAC) system according to an embodiment of the disclosure. As used herein, the term air can refer to fluid in a gaseous state, fluid in a liquid state, or any combination thereof. The air-handling system 1 typically provides heating, ventilation, and air conditioning for a passenger compartment of a vehicle (not depicted). The air-handling system 1 can be installed in various locations within the vehicle as desired such as under an instrument panel, to a dash panel, in a trunk, in a console, under a floor, in a headliner, or in an engine compartment, for example. It is understood that the air-handling system 1 may be employed in various other applications in addition to vehicles if desired.

The air-handling system 1 includes a hollow main housing 12. The main housing 12 may be formed by the cooperation of a pair of housing shells 16. In some embodiments, the housing shells 16 interface with each other along peripheral regions thereof to form the hollow main housing 12. The housing shells 16 may be formed from plastic, but other materials can be used, as desired. In other embodiments, the main housing 12 may be formed by the cooperation of three or more separately formed components or housing portions, as desired.

FIG. 1 illustrates a hollow interior of the main housing 12. The main housing 12 includes an inlet section 20, a conditioning section 21, a mixing section 22, and a delivery section 23. The inlet section 20 includes an air inlet 24 in fluid communication with a supply of air and an inlet conduit 25 providing fluid communication between the supply of air and the conditioning section 21 of the main housing 12. A selectively positionable inlet door (not shown) may be disposed in the inlet section 20 to control the flow of air into and through the air inlet 24. The supply of air can be provided from outside of the vehicle, recirculated from the passenger compartment of the vehicle, or a mixture of the two, for example. The air inlet 24 may be formed adjacent a blower or fan 26 of a blower assembly 27 configured to promote a flow of the supply of air through the inlet conduit 25. If desired, a filter 3 can be provided upstream or downstream of the inlet section 20 to filter out debris or contaminants carried by the supply of air.

As best seen in FIG. 1, the inlet section 20 includes a fluid drain 50 and a fluid outlet 52. In some embodiments, the fluid drain 50 and/or the fluid outlet 52 may be apertures formed in walls of the main housing 12. The fluid drain 50 and/or the fluid outlet 52 may be part of fluid ingression management systems 100, 200, 300 of the air-handling system 1, as described in detail hereinafter. The fluid drain 50 may be in fluid communication with the air inlet 24 and configured to permit a fluid (e.g., water) that collects within the air inlet 24 to flow from the air inlet 24 to the fluid outlet 52. The fluid outlet 52 may be formed in the inlet conduit 25 and in fluid communication with a surrounding environment to permit the fluid to flow from the fluid outlet 52 to an exterior of the air-handling system 1. The fluid outlet 52 may be formed as a fluid accumulator in a lower portion of the main housing 12 if desired. In certain instances, the fluid outlet 52 may be located directly below the filter 3 of the inlet section 20. It is understood that the fluid outlet 52 may be formed elsewhere in the main housing 12 if desired.

The conditioning section 21 may include an evaporator core 4 and a heater core 5. The evaporator core 4 may form a portion of a primary refrigerant circuit of the air conditioning system associated with the air-handling system 1. The evaporator core 4 is configured to exchange heat energy between the flow of air and the refrigerant flowing through the evaporator core 4 to cool and/or dehumidify the flow of air. Although described as an evaporator core, it should be understood that any form of cooling device in heat exchange relationship with any device or system of the vehicle may be employed for use with the air-handling system 1 without departing from the scope of the present invention. The heater core 5 may form a radiator associated with a coolant circuit used to cool an engine of the vehicle. The heater core 5 is further configured to exchange heat energy between the flow of air and a coolant circulated through the coolant circuit to heat the flow of air. Alternatively, the heater core 5 may be in heat exchange relationship with a fluid used to cool a battery or other heat producing device associated with the vehicle or the heater core 5 may be a heating device configured to produce heat using an electrical source. It should be understood that any form of heating device suitable for heating a flow of air therethrough may be used in place the heater core 5 without departing from the scope of the present invention.

As shown in FIG. 1, the evaporator core 4 may be disposed at an inlet region of the conditioning section 21 immediately downstream of the inlet conduit 25 and/or the filter 3 (if present) of the inlet section 20. The evaporator core 4 extends across an entirety of a flow area at the inlet region of the conditioning section 21 to cause the entirety of the flow of air to pass through the evaporator core 4, thereby cooling and/or dehumidifying the entirety of the flow of air as the flow of air enters the conditioning section 21.

After flowing through the evaporator core 4 the flow of air flows through a cold air passageway 7 and/or a warm air passageway 8 including the heater core 5 disposed therein. One or more selectively positionable temperature and mode doors 28, 30, respectively, are rotatably coupled to the main housing 12 at a downstream end of each of the cold air passageway 7, which may be divided into a first cold air passageway 7a and a second cold air passageway 7b, and the warm air passageway 8. The temperature and mode doors 28 are selectively positionable to control the flow of the air through the mixing and delivery sections 22, 23. The temperature door 28 may be positioned in a first position wherein the temperature door 28 is rotated to block passage of the flow of air through the warm air passageway 8, may alternatively be positioned in a second position wherein the temperature door 28 is rotated to block passage of the flow of air through the cold air passageway 7, may alternatively be rotated to an intermediate position between the first position and the second position to control a percentage of the flow of air passing through the cold air passageway 7 and the warm air passageway 8.

The delivery section 23 of the main housing 12 includes a plurality of conduits 9, 10, 11, 13. More or less conduits then shown may be formed in the delivery section 23 of the main housing 12 if desired. The conduits 9, 10, 11 may be an “upper conduits” for directing the flow of air towards one or more “upper vents” of the air-handling system 1 directed towards a first region of the passenger compartment including a windshield and/or a passenger within the passenger compartment. The conduit 13 may be a “lower conduit” for directing the flow of air towards one or more “lower vents” directed towards a second region of the passenger compartment including a console area of the passenger compartment. However, the conduits 9, 10, 11, 13 may direct the flow of air to various different regions or vents of the air-handling system 1 without departing from the scope of the present invention.

The mode doors 30 are rotatably coupled to the main housing 12 between the mixing section 22 and the delivery section 23. The mode doors 30 may be positioned in a first position wherein the mode doors 30 are rotated to block passage of the flow of air into the conduits 9, 10, 11, 13, may alternatively be positioned in a second position wherein the mode doors 30 are rotated to permit at least a partial flow, if not an entirety, of the flow of air to flow into and through the conduits 9, 10, 11, 13, may alternatively be rotated to an intermediate position between the first position and the second position to control a percentage of the flow of air directed to each of the conduits 9, 10, 11, 13.

The inlet door, temperature door, and the mode doors of the air-handling system 1 may be controlled independently by at least one actuator (not depicted) to achieve a variety of different flow configurations of the flow of air, thereby allowing for a volume, a temperature, and a venting direction of the flow of air to be controlled within the passenger compartment of the vehicle.

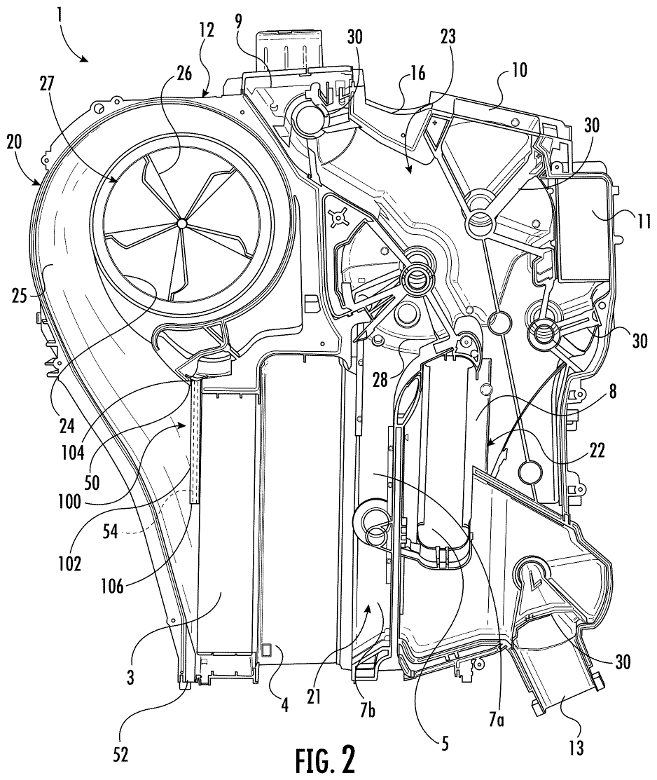

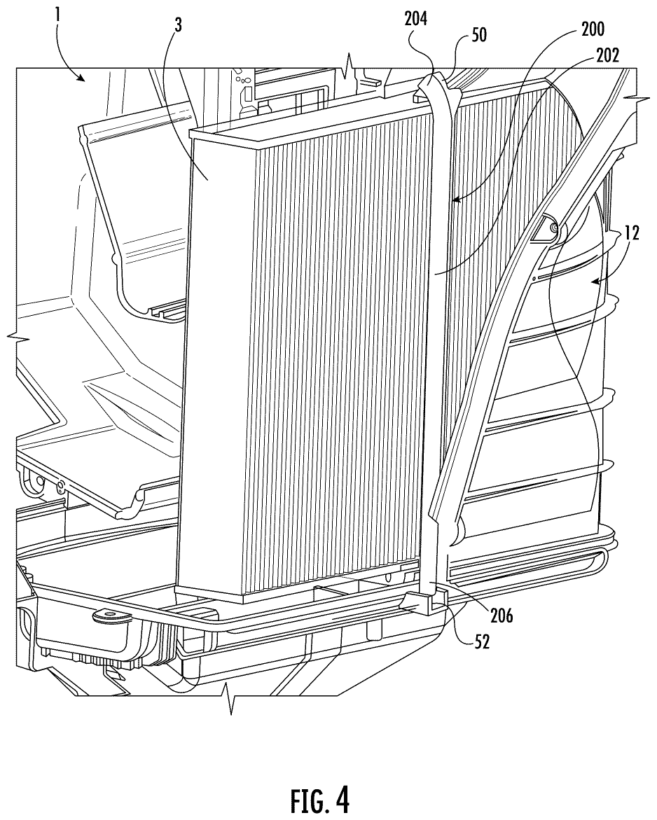

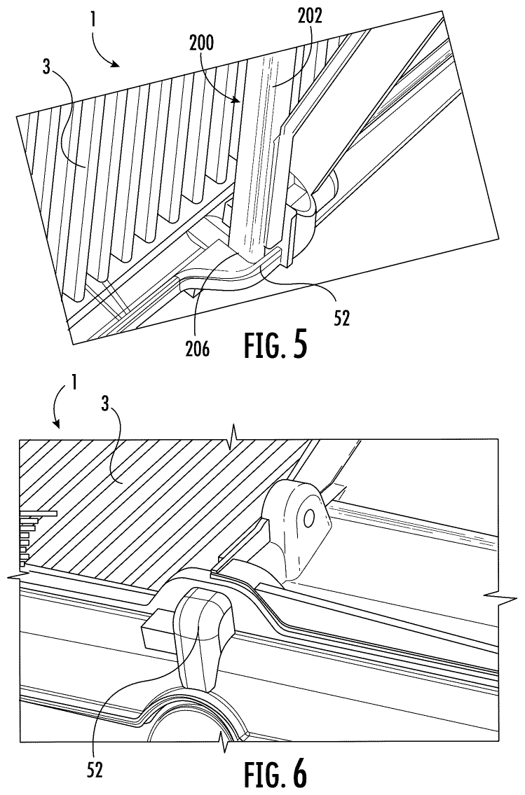

Turning now to FIGS. 2-11, exemplary embodiments of the fluid ingression management system 100, 200, 300 are illustrated. Each of the fluid ingression management systems 100, 200, 300 includes a fluid passageway 54 configured to permit the flow of the fluid from the fluid drain 50 in fluid communication with the air inlet 24, through the fluid outlet 52 of the inlet conduit 25, to the exterior of the air-handling system 1.

In an embodiment of the fluid ingression management system 100 shown in FIG. 2, a tube-like structure 102 defines the fluid passageway 54. The tube-like structure 102 extends from the fluid drain 50. As illustrated, the tube-like structure 102 extends between the fluid drain 50 and the fluid outlet 52. One end 104 of the tube-like structure 102 may be in fluid communication with the fluid drain 50 and another end 106 of the tube-like structure 102 may be a free end. In certain instances, the end 104 of the tube-like structure 102 may be directly connected to the fluid drain 50.

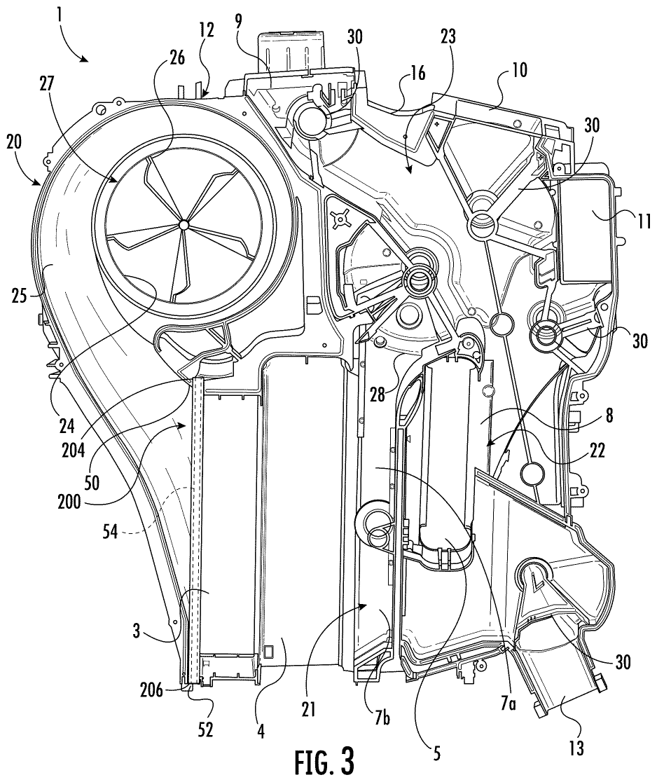

In another embodiment of the fluid ingression management system 200 shown in FIGS. 3-6, a tube-like structure 202 defines the fluid passageway 54. Like the tube-like structure 102, the tube-like structure 202 extends between the fluid drain 50 and the fluid outlet 52. One end 204 of the tube-like structure 202 may be in fluid communication with the fluid drain 50 and another end 206 of the tube-like structure 202 may be in fluid communication with the fluid outlet 52. In particular, the end 204 may be directly connected to the fluid drain 50 and the end 206 may directly connected to the fluid outlet 52.

A length of the tube-like structures 102, 202 is critical to an operation of the fluid ingression management systems 100, 200. A pressure of the tube-like structure 102, 202 must be greater than a chamber pressure of the air inlet 24 to provide adequate flow of the fluid therefrom. When the pressure of the tube-like structure 102, 202 is less than the chamber pressure, there is no flow of the fluid from the air inlet 24 and/or the fluid bubbles therein. When the pressure of the tube-like structure 102, 202 is equal to the chamber pressure, the flow of the fluid is stable, but not adequate.

In a non-limiting example, the chamber pressure of the air inlet 24 during operation of the blower assembly 27 of the air-handling system 1 is about 450 Pa. As such, a height of a column of fluid using the equation Pressure=(density of fluid)*(acceleration due to gravity)*(height of a column of fluid) must be at least 0.046 m (i.e., 45 mm), wherein the pressure is 450 Pa, the density of the fluid is 1000 kg/m³, and the acceleration due to gravity is 9.8 m/s. Thus, the length of the tube-like structures 102, 202 may be at least 50 mm.

In particular embodiments, the length of the tube-like structures 102, 202 may be in a range of about 50 mm to about 300 mm. In the embodiment shown in FIG. 2, the length of the tube-like structure 102 may be about 80 mm. In another embodiment shown in FIGS. 3-6, the length of the tube-like structure 202 may be about 250 mm. An inner diameter of the tube-like structures 102, 202 may be generally uniform along an entirety of the length of the tube-like structures 102, 202, as best shown in FIGS. 2 and 3. It is understood, however, that the inner diameter may vary along the length of the tube-like structures 102, 202, if desired. In some embodiments, the inner diameter may be in a range of about 5 mm to about 10 mm. It is understood that the length and inner diameter of the tube-like structures 102, 202 may be any suitable size and configuration as desired to permit the flow of the fluid therethrough.

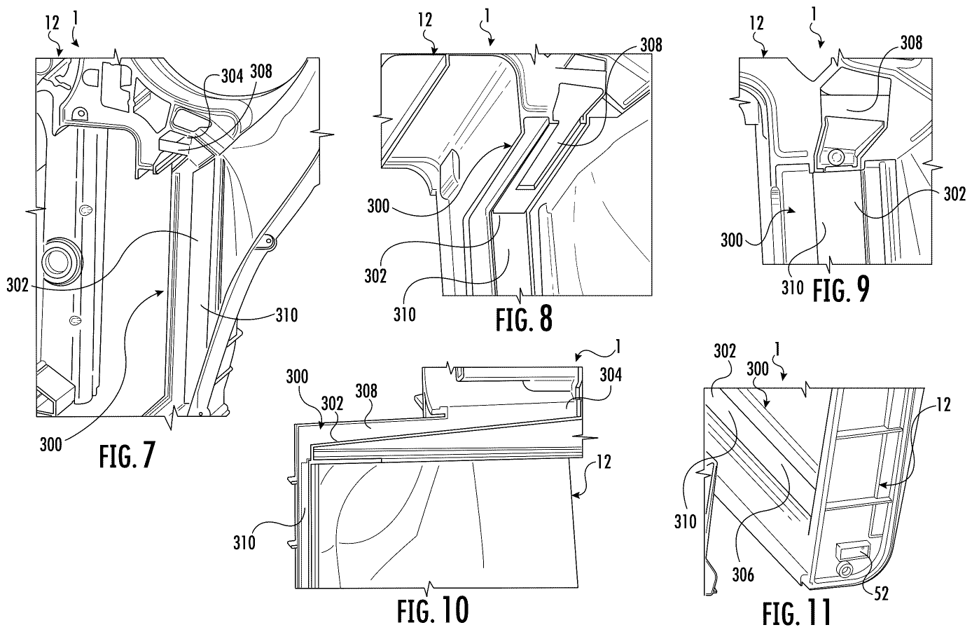

Referring to FIGS. 7-11, the fluid passageway 54 of the fluid ingression management system 300 is defined by at least one fluid channel 302. One end 304 of the fluid channel 302 may be in fluid communication with the fluid drain 50 and another end 304 of the fluid channel 302 may be in fluid communication with the fluid outlet 52. In particular, the end 304 of the fluid channel 302 may be directly connected to the fluid drain 50 and the end 306 may be directly connected to the fluid outlet 52. As more clearly shown in FIG. 10, a portion 308 of the fluid channel 302 is formed at an angle in range of about 3 degrees to about 10 degrees relative to a horizontal axis to facilitate the flow of the fluid away from the fluid drain 50 and another portion 310 of the fluid channel 302 is relatively parallel to a vertical axis. As depicted, the portion 310 of the fluid channel 302 may be formed in a wall of the main housing 12. It should be appreciated that the fluid channel 302 may be formed in the main housing 12 as desired.

Advantageously, the fluid ingression management systems 100, 200, 300 provide improved drainage of the fluid that enters the air inlet 24 of the air-handling system 1 during both operation and inactivity of the blower assembly 27. The fluid ingression management systems 100, 200, 300 overcome the back pressure caused by the operation of the blower assembly 27 and, thereby, prevent such fluid from flowing into undesired locations of the air-handling system 1 and reaching components that are susceptible to damage. In particular, the fluid that enters the air inlet 24 of the air-handling system 1 flows into the fluid drain 50, through the fluid passageway 54, and exits to the exterior of the air-handling system 1 through the fluid outlet 52. Accordingly, the use of the fluid ingression management systems 100, 200, 300 of the present disclosure lead to decreased energy consumption and increased efficiency as well as reduced wear on the overall air-handling system 1.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An air-handling system for a heating, ventilation, and air conditioning system of a vehicle, comprising:
a main housing having an air inlet; and
a fluid ingression management system including a fluid drain in fluid communication with the air inlet, a fluid outlet in fluid communication with an exterior of the air-handling system, and a fluid passageway disposed between the fluid drain and the fluid outlet, wherein the fluid passageway is configured to permit a flow of a fluid from the air inlet to the exterior of the air-handling system.

2. The air-handling system of claim 1, wherein a tube-like structure defines the fluid passageway.

3. The air-handling system of claim 2, wherein the tube-like structure extends from the fluid drain.

4. The air-handling system of claim 2, wherein one end of the tube-like structure is in fluid communication with the fluid drain and another end of the tube-like structure is a free end.

5. The air-handling system of claim 2, wherein the tube-like structure extends between the fluid drain and the fluid outlet.

6. The air-handling system of claim 2, wherein one end of the tube-like structure is in fluid communication with the fluid drain and another end of the tube-like structure is in fluid communication with the fluid outlet.

7. The air-handling system of claim 2, wherein one end of the tube-like structure is directly connected to the fluid drain.

8. The air-handling system of claim 2, wherein one end of the tube-like structure is directly connected to the fluid outlet.

9. The air-handling system of claim 2, wherein a length of the tube-like structure is at least about 50 mm.

10. The air-handling system of claim 2, wherein a length of the tube-like structure is in a range of about 50 mm to about 300 mm.

11. The air-handling system of claim 2, wherein a length of the tube-like structure is about 80 mm.

12. The air-handling system of claim 2, wherein a length of the tube-like structure is about 250 mm.

13. The air-handling system of claim 2, wherein an inner diameter of the tube-like structure is in a range of about 5 mm to about 10 mm.

14. The air-handling system of claim 1, wherein one or more fluid channels define the fluid passageway.

15. The air-handling system of claim 14, wherein one end of the fluid channels is in fluid communication with the fluid drain and another end of the fluid channels is in fluid communication with the fluid outlet.

16. The air-handling system of claim 14, wherein one end of the fluid channels is directly connected to the fluid drain.

17. The air-handling system of claim 14, wherein one end of the fluid channels is directly connected to the fluid outlet.

18. The air-handling system of claim 14, wherein a portion of the fluid channels is at an angle in range of about 3 degrees to about 10 degrees relative to a horizontal axis to facilitate the flow of the fluid away from the fluid drain.

19. The air-handling system of claim 14, wherein a portion of the fluid channels is relatively parallel to a vertical axis.

20. The air-handling system of claim 14, wherein at least a portion of the fluid channels is formed in a wall of the main housing.
